(19) United States
(12) Patent Application Publication
(10) Pub. No.: US 2023/0411069 A1
(43) Pub. Date: Dec. 21, 2023

(54) ELECTRONIC COMPONENT AND METHOD OF MANUFACTURING THE SAME

(71) Applicant: TDK CORPORATION, Tokyo (JP)

(72) Inventors: Shintarou KOIKE, Tokyo (JP); Kazushige TOHTA, Tokyo (JP); Takuto KAZAMA, Tokyo (JP); Masashi GOTOH, Tokyo (JP)

(73) Assignee: TDK CORPORATION, Tokyo (JP)

(21) Appl. No.: 18/320,266

(22) Filed: May 19, 2023

(30) Foreign Application Priority Data
May 20, 2022 (JP) 2022-083157
May 17, 2023 (JP) 2023-081753

(51) Int. Cl. H01F 27/29; H01F 41/10; H01F 27/02; H01F 27/28

(52) U.S. Cl. CPC H01F 27/292; H01F 27/2828; H01F 27/022; H01F 41/10

(57) ABSTRACT

An electronic component includes an element body, an electric element embedded inside the element body, and an electrode terminal connected to the electric element so as to be exposed to an outer surface of the element body. The electrode terminal includes a terminal body continuously and integrally formed with a wire of the electric element embedded inside the element body and extending in a planar shape along a main surface of the element body. The wire is drawn out to an outside of the element body from the main surface of the element body to form the electrode terminal.

### CROSS REFERENCE TO RELATED APPLICATION

This application claims priority based on Japanese Patent Application No. 2022-083157 filed on May 20, 2022 and Japanese Patent Application No. 2023-081753 filed on May 17, 2023, and the whole of the disclosure of the above application is incorporated herein by reference.

### BACKGROUND

The present disclosure relates to an electronic component in which an electric element, such as a coil, is embedded in an element body and a method of manufacturing the same.

Along with a smaller size and higher performance of recent electronic equipment, electronic components included in the electronic equipment are increasingly having a smaller size and higher performance. As the electronic components reduce in size, the electronic components normally tend to have weaker mechanical strength. Nevertheless, still higher performance and still higher reliability of the electronic components are in demand.

To respond to such size reduction of the electronic components, for example, in an electronic component described in Patent Document 1, an end of a wire wound around a winding portion of a core is flattened and bent to connect to a terminal electrode placed at a flange of the core. This reduces pressure applied by thermocompression bonding means to the flange at the time of connection and prevents damage to the flange thinned by size reduction.
Patent Document 1: JP Patent Application Laid Open No. 2007-165539

### SUMMARY

An electronic component according to an aspect of the present disclosure includes:
an element body, an electric element embedded inside the element body, and an electrode terminal connected to the electric element so as to be exposed to an outer surface of the element body,
wherein
the electrode terminal includes a terminal body continuously and integrally formed with a wire of the electric element embedded inside the element body and extending in a planar shape along a main surface of the element body; and
the wire is drawn out to an outside of the element body from the main surface of the element body to form the electrode terminal.

Because the electrode terminal of the electronic component having such a structure is continuously and integrally formed with the wire of the electric element embedded inside the element body, no separate member for connecting the electric element and the electrode terminal is needed. Consequently, the electronic component can be reduced in size.

A method of manufacturing an electronic component, according to an aspect of the present disclosure, includes:
forming an electrode terminal by processing an end of a wire of an electric element into a sheet shape so that the end has a thickness smaller than that of the wire apart from the end and a width larger than that of the wire apart from the end; and
forming an element body so that an outer surface of the electrode terminal is exposed from the element body and the electric element is covered by the element body.

### BRIEF DESCRIPTION OF THE DRAWINGS

FIG. 1A is a transparent perspective view of a coil component according to a first aspect of the subject technology.

FIG. 1B is an external perspective view of the coil component shown in FIG. 1A viewed from a mounting surface side of the coil component.

FIG. 2A is a transparent front elevational view of the coil component shown in FIG. 1A.

FIG. 2B is a transparent bottom plan view of the coil component shown in FIG. 1A.

FIG. 2C is a transparent side elevational view of the coil component shown in FIG. 1A.

FIG. 2D is an enlarged diagram of a region IID shown in FIG. 2A.

FIG. 2E is a perspective view of an electrode terminal of the coil component shown in FIG. 1A.

FIG. 2F is a perspective view of a modified example of the electrode terminal shown in FIG. 2E.

FIG. 2G is a perspective view of the electrode terminal shown in FIG. 2E viewed from another angle.

FIG. 2H is a perspective view of another modified example of the electrode terminal shown in FIG. 2G.

FIG. 3A is a flowchart of a method of manufacturing the coil component shown in FIG. 1A.

FIG. 3B is a diagram illustrative of an example of a wire winding step of FIG. 3A.

FIG. 3C is a diagram illustrative of an example of a wire squeezing step of FIG. 3A.

FIG. 3D is a diagram illustrative of an example of a terminal forming step of FIG. 3A.

FIG. 3E is a diagram illustrative of an example of a plating treatment step of FIG. 3A.

FIG. 4A is a transparent perspective view of a coil component according to a second aspect of the subject technology.

FIG. 4B is a transparent front elevational view of the coil component shown in FIG. 4A.

FIG. 4C is a transparent perspective view of a coil component according to a third aspect of the subject technology.

FIG. 4D is a transparent perspective view of a coil component according to a fourth aspect of the subject technology.

FIG. 4E is a transparent bottom plan view of the coil component shown in FIG. 4D.

FIG. 5A is a diagram illustrative of a method of manufacturing the coil component shown in FIG. 4D.

FIG. 6A is a first schematic view illustrative of an electrode terminal of a coil component according to a fifth aspect of the subject technology.

FIG. 6B is a second schematic view illustrative of the electrode terminal of the coil component according to the fifth aspect of the subject technology.

### DETAILED DESCRIPTION

Hereinafter, embodiments of the present disclosure will be explained with reference to the drawings. The following embodiments of the present disclosure are illustrative exemplifications of the present disclosure. Various components, such as numerical values, shapes, materials, and manufacturing steps, according to the embodiments of the present disclosure may be modified or changed to the extent that technical problems do not arise.

Shapes and the like illustrated in the drawings of the present disclosure do not necessarily match actual shapes and the like, because the former may be modified for illustration purposes.

### First Embodiment

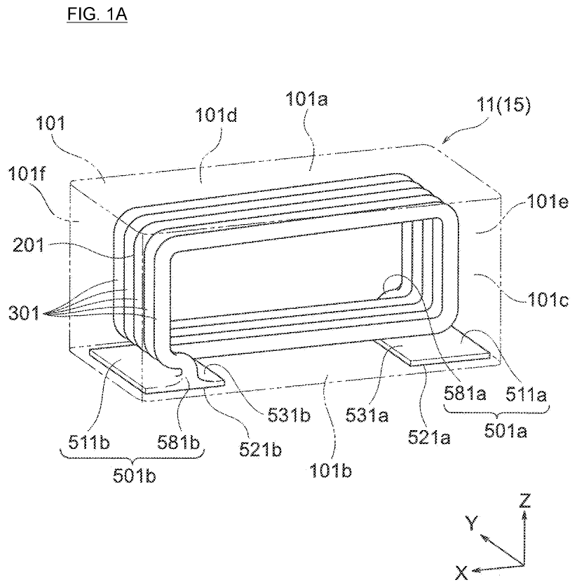

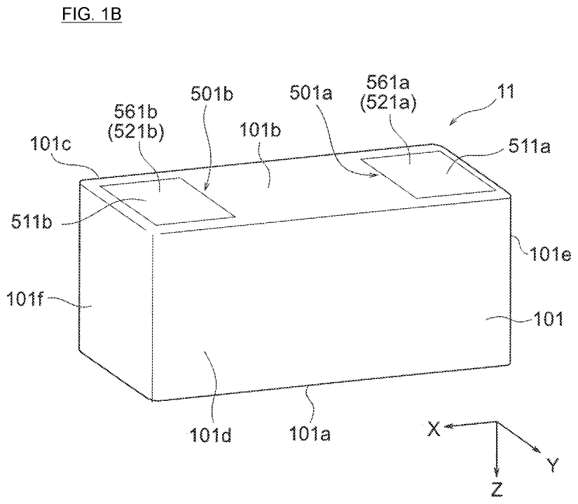

A coil component 11 of a first embodiment will be explained with reference to FIGS. 1A to 3E.

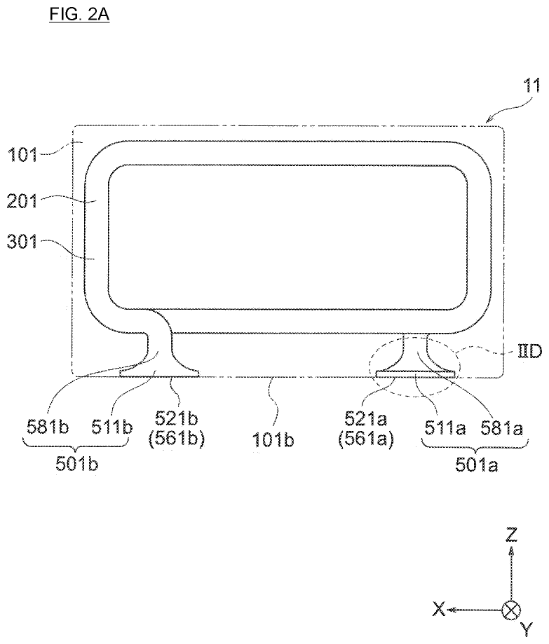

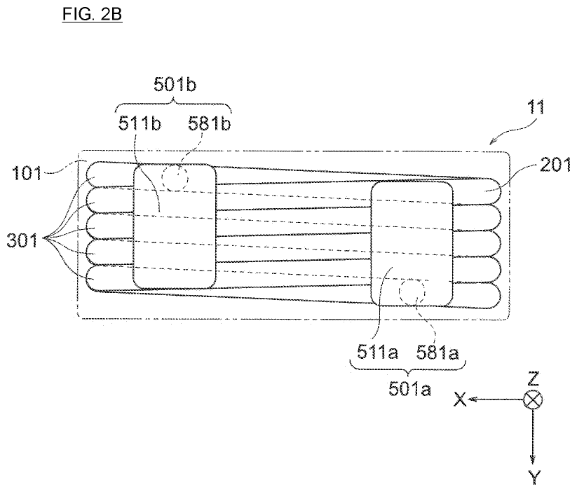

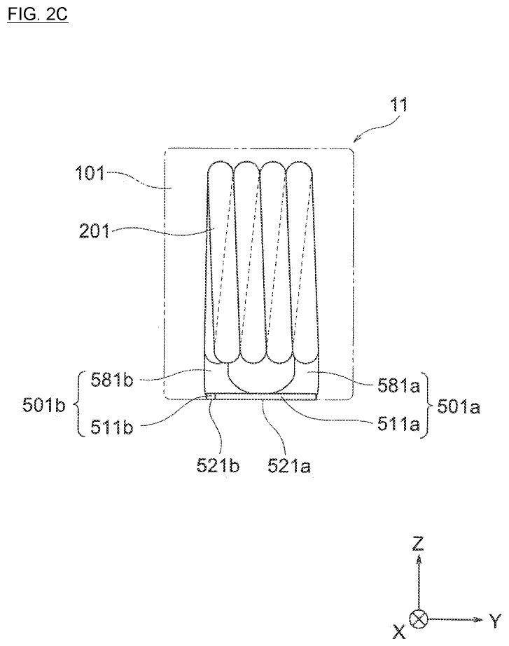

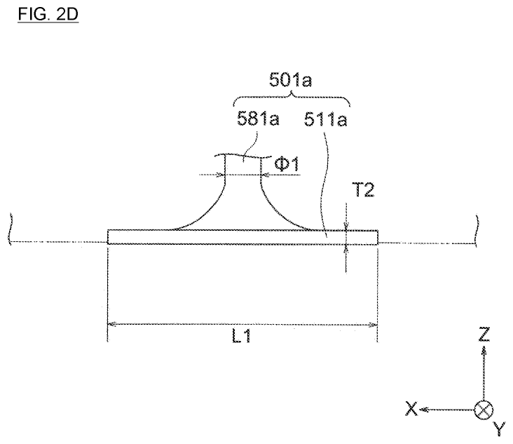

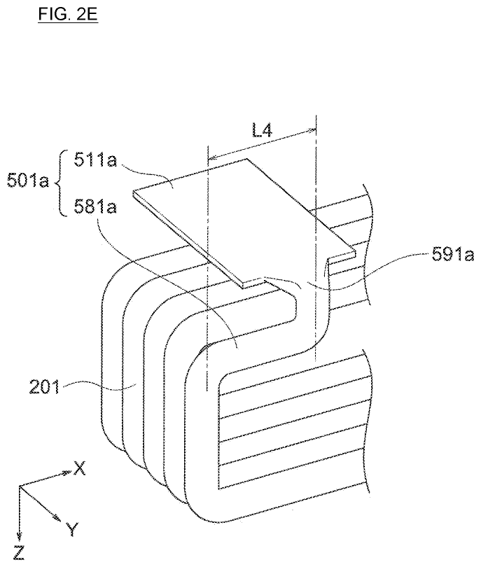

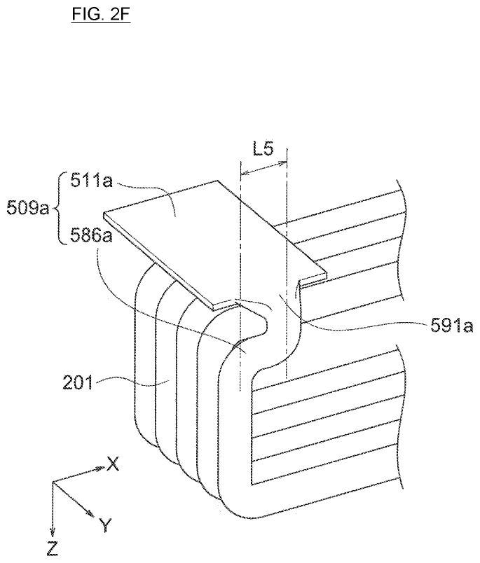

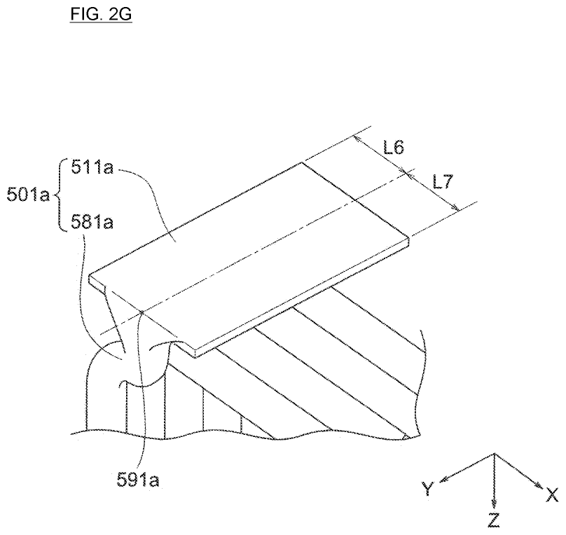

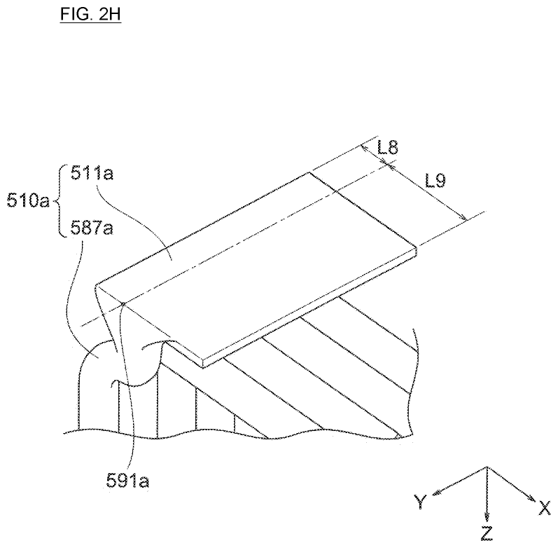

As shown in FIGS. 1A to 2C, the coil component 11 is an electronic component in which an element body 101 is sealed to accommodate an air core coil (a coil portion) 201 as an electric element inside, i.e., an electronic component in which the air core coil is embedded in the element body 101. The coil component 11 includes the element body 101, the coil portion 201, and a pair of electrode terminals 501a and 501b.

The coil component 11 of the present embodiment is a small electronic component having a length of, for example, 5 mm or less, 3 mm or less, or 0.5 mm or less as a length of a longest side in a plane direction and a height of, for example, 5 mm or less, 3 mm or less, or 0.5 mm or less.

The element body 101 is an exterior member that is sealed to accommodate the coil portion 201 inside. As shown in FIGS. 1A and 1B, the element body 101 has a rectangular parallelepiped shape (hexahedral shape) and includes an upper surface 101a, a bottom surface 101b opposite the upper surface 101a in a Z-axis direction, X-axis direction side surfaces 101e and 101f, which are opposite each other along an X-axis, and Y-axis direction side surfaces 101c and 101d, which are opposite each other along a Y-axis. In the present disclosure, rectangular parallelepipeds include a rectangular parallelepiped having chamfered corners and chamfered ridges and a rectangular parallelepiped having rounded corners and rounded ridges.

In the present embodiment, the element body 101 contains a resin material that does not include a magnetic powder. Such a structure reduces permittivity of the element body 101 to allow the coil component 11 to be suitably used at high frequencies. Material of the element body 101 includes, for example, at least one of a thermosetting resin or a thermoplastic resin. The material of the element body 101 includes, for example, at least one selected from the group consisting of an epoxy resin, a polyimide resin, a phenol resin, and an unsaturated polyester resin, as a thermosetting resin. The polyimide resin is, for example, a bismaleimide resin. The material of the element body 101 includes, for example, at least one selected from the group consisting of crystalline polystyrene, a fluorine resin, polyethylene, a liquid crystal polymer, and polyphenylene sulfide (PPS), as a thermoplastic resin. The fluorine resin is, for example, a polytetrafluoroethylene (PTFE) resin. The element body may be composed of a filler-containing resin in which the above-mentioned resins include filler, such as hollow glass and acicular glass. As described later as a modified example, the element body 101 may be composed of a magnetic powder-containing resin that includes a magnetic powder.

The bottom surface 101b of the element body 101 is formed as a main surface that faces a component installation surface (mounting surface) of a substrate or the like where the coil component 11 is to be mounted. At the bottom surface (main surface) 101b, first main surfaces (electrode terminal outer surfaces) 521a and 521b, which are outer surfaces of terminal bodies 511a and 511b of the respective electrode terminals 501a and 501b, are exposed. The electrode terminal outer surfaces 521a and 521b are disposed at the bottom surface 101b apart from each other in the X-axis direction, and the terminal bodies 511a and 511b are insulated from each other.

The electrode terminal outer surfaces 521a and 521b of the coil component 11 can be connected to an external circuit through an interconnection (not illustrated) such as wiring. The coil component 11 may be mounted on various substrates (e.g., circuit substrates) using a joining member (e.g., solder and conductive adhesive). When the coil component 11 is mounted on a substrate, the bottom surface (main surface) 101b becomes a mounting surface (mounting surface of the coil component), and the electrode terminal outer surfaces 521a and 521b are electrically connected to lands or the like constituting part of an electric circuit formed on the substrate or the like.

In the present embodiment, the coil component 11 is explained on the basis that a direction perpendicular to the main surface 101b of the coil component 11 is the Z-axis direction; a direction along the direction in which the pair of electrode terminals 501a and 501b is disposed (a direction along one of the two pairs of facing edges forming a periphery of the main surface 101b) is the X-axis direction; and a direction orthogonal to the X-axis direction and the Z-axis direction is the Y-axis direction.

The coil portion 201 is composed of a wire 301 wound in a coil shape as a conductor. In the present embodiment, the coil portion 201 is accommodated in the element body 101 so that the winding axis of the coil portion 201 is parallel to the mounting surface (vertical placement). Although the coil portion 201 of the coil component 11 of the present embodiment is a coil in which the wire 301 is wound in a typical normal-wise manner, the wire may be wound in any manner. For example, the coil portion 201 may be a coil in which the wire 301 is α-wound, flat wound, or edgewise wound.

The wire 301 is composed of a conductor portion mainly containing low resistance metal (e.g., copper) and an insulating layer covering an outer periphery of the conductor portion. More specifically, the conductor portion is composed of pure copper (e.g., oxygen-free copper and tough pitch copper), an alloy that contains copper (e.g., phosphor bronze, brass, red brass, beryllium copper, and a silver-copper alloy), a copper-coated steel wire, or the like.

The insulating layer is made of any electrically insulating material. Examples of the material include an epoxy resin, an acrylic resin, polyurethane, polyimide, polyamide-imide, polyester imide, nylon, polyester, polyvinyl formal, and a synthetic resin in which at least two of the above resins are mixed.

Although the wire 301 of the coil portion 201 is a round wire whose conductor portion has a circular sectional shape in the present embodiment, the wire 301 is not limited to a round wire and may be other wires, such as a wire having a rectangular sectional shape and a flat wire. The conductor portion of the wire 301 of the present embodiment has an outer diameter Φ1 (see FIG. 2D) determined so that the wire 301 has a sectional area of, for example, 1.96×10⁻¹¹ m² to 1×10⁻⁸ m² regardless of the sectional shape. Specifically, the outer diameter Φ1 may be 5 μm to 100 μm and may be 10 μm to 50 μm.

Although the shape of the coil portion 201 in a plane perpendicular to the winding axis of the coil portion 201 in the present embodiment is a rectangle (square frame shape) having gently curved, arc-shaped corners, the shape of the coil portion 201 viewed from the winding axis direction is not limited to such a shape and may be, for example, elliptical, oval, or a perfect circle.

At both ends of the wire 301 of the coil portion 201, the electrode terminals 501a and 501b are formed. The electrode terminals 501a and 501b include the respective terminal bodies 511a and 511b having the respective electrode surfaces (electrode terminal outer surfaces) 521a and 521b exposed to an outer side of the coil component 11 from the main surface 101b, and respective lead-out portions 581a and 581b connecting the coil portion 201 and the terminal bodies 511a and 511b.

The electrode terminals 501a and 501b are formed by processing part drawn out from the coil portion 201 at both ends of the wire 301 of the coil portion 201. Both ends of the wire 301 of the coil portion 201, i.e., a winding start part and a winding end part of the wire 301, are disposed at near diagonal positions of the main surface 101b in an X-Y plane and closer to the main surface 101b in the Z-axis direction (at a lower side in the Z-axis direction), as is evident from FIGS. 2A to 2C. The electrode terminals 501a and 501b are formed by processing end extremities of the wire 301 that continue from the winding start part and the winding end part.

Each of the terminal bodies 511a and 511b is, for example, a sheet-shaped member having a rectangular planar shape as shown in FIG. 2B and a small thickness as shown in FIG. 2A. Each of the terminal bodies 511a and 511b is formed by squeezing the wire 301. Consequently, in a cross section orthogonal to the extending direction of the wire 301, the terminal bodies 511a and 511b have a thickness smaller (thinner) than the outer diameter (minimum value of the conductor portion and also referred to as “thickness of the wire” when the conductor portion has a sectional shape other than a circle) of the conductor portion of the wire 301 of the coil portion 201, and have a width larger (wider) than the outer diameter (maximum value of the conductor portion and also referred to as “width of the wire” when the conductor portion has a sectional shape other than a circle).

In the present embodiment, as shown in FIG. 2D, a thickness T2 of the terminal bodies 511a and 511b is small with respect to the outer diameter Φ1 of the conductor portion of the wire 301. For example, the thickness T2 may be 50% or less (½ or less) of the outer diameter of the conductor portion of the wire 301, and a minimum value of the thickness T2 may be 5% or more ( 1/20 or more), 10% or more ( 1/10 or more), or 25% or more (¼ or more) of the outer diameter Φ1 of the conductor portion of the wire 301. Specifically, the thickness T2 of the terminal bodies 511a and 511b may be 3 μm to 60 μm, 5 μm to 60 μm, or 8 μm to 60 μm, when the outer diameter Φ1 of the conductor portion of the wire 301 is, for example, 5 μm to 100 μm.

Increasing the thickness T2 of the terminal bodies 511a and 511b can improve absolute strength of the electrode terminals 501a and 501b, prevent rupture of the electrode terminals 501a and 501b, and improve adhesion strength (shear strength) between the electrode terminals 501a and 501b and the element body 101.

A width (length in a direction orthogonal to the extending direction of the wire 301) L1 of the terminal bodies 511a and 511b is large with respect to the outer diameter Φ1 of the conductor portion of the wire 301. For example, the width L1 may be two or more times larger than the outer diameter Φ1 of the conductor portion of the wire 301 and may be six or less times larger than the outer diameter Φ1 of the conductor portion of the wire 301. Specifically, the width L1 of the terminal bodies 511a and 511b is, for example, 10 μm to 600 μm and may be as wide so that the electrode terminals 501a and 501b are apart by a distance of 100 μm or more in the X-axis direction at the bottom surface 101b.

The lead-out portions 581a and 581b are drawn towards the main surface 101b from a bottom surface (which is on the main surface 101b side) of the coil portion 201 as shown in FIG. 2A. This structure allows the lead-out portions 581a and 581b to be disposed inside a region occupied by the coil portion 201 in the mounting surface (X-Y plane), enabling reduction of the size of the coil component 11 in a horizontal direction (in a plane parallel to the mounting surface).

The terminal bodies 511a and 511b are disposed between the bottom surface (which is on the main surface 101b side) of the coil portion 201 and the main surface 101b as shown in FIG. 2A. This structure allows the terminal bodies 511a and 511b to be disposed inside the region occupied by the coil portion 201 in the mounting surface (X-Y plane), enabling reduction of the size of the coil component 11 in the horizontal direction (in the plane parallel to the mounting surface). The equivalent series resistance (ESR) of the coil component 11 can also be reduced.

The terminal bodies 511a and 511b are disposed at substantially facing locations at both sides in the longitudinal direction (X-axis direction) of the main surface 101b as shown in FIG. 2B. However, arrangement of the terminal bodies 511a and 511b in the plane (X-Y plane) parallel to the mounting surface is not limited thereto, and the terminal bodies 511a and 511b may be disposed in any arrangement that falls within the region where the coil portion 201 is disposed and ensures insulation between the two terminal bodies 511a and 511b.

The terminal bodies 511a and 511b include the respective outer surfaces 521a and 521b, which are formed along the bottom surface 101b of the element body 101 so as to be exposed to the outer side of the coil component 11, and respective second main surfaces (inner surfaces) 531a and 531b, which are opposite the first main surfaces (outer surfaces) 521a and 521b and are oriented towards the inside of the coil component 11 to firmly adhere to the element body 101. Although the electrode terminals 501a and 501b are, as explained above, composed of the wire 301 having been processed, at the locations of the terminal bodies 511a and 511b, the insulating layer at the outer periphery side of the wire 301 is removed, and the conductor portion of the wire 301 is exposed.

In the present embodiment, the electrode terminal outer surfaces 521a and 521b are formed so that they are flush with the main surface 101b of the coil component 11 (as flat surfaces forming the same plane). However, the electrode terminal outer surfaces 521a and 521b may be formed so that they protrude from the main surface 101b or so that they are recessed from the main surface 101b. Also, the electrode terminal outer surfaces 521a and 521b may have uneven surface roughness.

At the electrode terminal outer surfaces 521a and 521b of the terminal bodies 511a and 511b having the exposed conductor portion, plating films 561a and 561b are formed respectively. The plating films 561a and 561b may be composed of metal, such as Sn, Au, Cu, Ni, Pt, Ag, and Pd, or an alloy containing at least one of these metal elements formed into a film shape by plating. This type of film may be formed by other methods, such as sputtering. The plating films 561a and 561b have a thickness of, for example, 50 μm or less.

Forming such plating films 561a and 561b improves flatness of the electrode terminal outer surfaces 521a and 521b and increases bondability or wettability of the joining member (e.g., solder and conductive adhesive) for mounting the coil component 11 on the substrate or the like, allowing for solid connection via the electrode terminals 501a and 501b, i.e., solid mounting of the coil component 11. However, the plating films 561a and 561b are not necessarily formed.

The electrode terminals 501a and 501b are disposed between the bottom surface of the coil portion 201 and the main surface (bottom surface) 101b of the element body 101. That is, in the plane (X-Y plane) parallel to the mounting surface, the terminal bodies 511a and 511b and the lead-out portions 581a and 581b are disposed in the region where the coil portion 201 is disposed. This allows for a smaller size of the coil component 11.

For such arrangement, the terminal body may extend in the planar shape along the main surface in a direction towards a center of the electric element. The lead-out portions 581a and 581b are disposed so that the wire 301 extends away from outer sides of the coil portion 201 (outer sides in the X-axis direction) towards an inner side thereof (inner side in the X-axis direction) (e.g., towards the winding axis of the air core coil) as shown in FIG. 2A. Then, at the inner side of the coil portion 201, the wire 301 is bent towards the main surface 101b of the element body 101 (in the Z-axis direction) to connect to the terminal bodies 511a and 511b disposed along the main surface 101b.

More specifically, as shown in FIG. 2E, the lead-out portions 581a and 581b extend from respective lower corners of the air core coil 201 towards the inner side in the X-axis direction along the wound wire 301 (wire of the air core coil 201), are bent downwards in the Z-axis direction at respective locations away by a length L4 (center-to-center distance of the wire) towards the inner side, and are connected to the respective terminal bodies 511a and 511b.

Consequently, the terminal bodies 511a and 511b are solidly disposed between the bottom surface of the coil portion 201 and the bottom surface 101b of the element body 101 and can be disposed within the region occupied by the coil portion 201 in the mounting surface (X-Y plane).

The length L4, which is the length of the wire 301 as the lead-out portions 581a and 581b disposed towards a center side of the coil portion 201, may be any length. However, at the maximum, the length L4 is as long as a distance at which insulation between the two terminal bodies 511a and 511b facing each other in the X-axis direction can be ensured, i.e., a distance at which the two terminal bodies 511a and 511b are not too close to each other.

At the minimum, the length L4, which is the length of the wire 301 disposed towards the inner side, is as long so that edges of the terminal bodies 511a and 511b substantially match those of the air core coil 201 in the X-axis direction, which is L5 shown in FIG. 2F. Even with such a structure, provided that the terminal bodies 511a and 511b are disposed below the coil portion 201 in the Z-axis direction, need for increasing the size of the coil component 11 for the electrode terminals 501a and 501b is eliminated, and the coil component 11 can have a smaller size.

As shown in FIG. 2G, in the width direction (X-axis direction) of the terminal body 511a (511b), a location 591a where the lead-out portion 581a (581b) is formed with respect to the terminal body 511a (511b) (a lead-out formation location, a location of a center of the lead-out portion 581a (581b)) is substantially a center of the terminal body 511a (511b) in the width direction (X-axis direction). That is, a ratio L6:L7 is, for example, 40:60 to 60:40, where L6 is the length between the lead-out formation location 591a and an outer-side edge of the terminal body 511a (511b) in the width direction (X-axis direction) and L7 is the length between the lead-out formation location 591a and an inner-side edge of the terminal body 511a (511b) in the width direction.

However, for example, as shown in FIG. 2H, by disposing the lead-out formation location 591a more to an outer side of the center of the terminal body 511a (511b) in the width direction, a ratio L8:L9 may satisfy 10:90 to 40:60, where L8 is the length between the lead-out formation location 591a and the outer-side edge of the terminal body and L9 is the length between the lead-out formation location 591a and the inner-side edge of the terminal body. Such a structure allows the terminal bodies 511a and 511b to be disposed within the region below the coil portion 201 in the Z-axis direction while reducing the length L4 (or L5), which is the length of the lead-out portions 581a and 581b routed inwards with reference to FIGS. 2E and 2F. Further, such a structure can reduce the length of the lead-out portions 581a and 581b extending inwards along winding part of the coil portion 201 and reduce impacts on coil characteristics by the lead-out portions 581a and 581b.

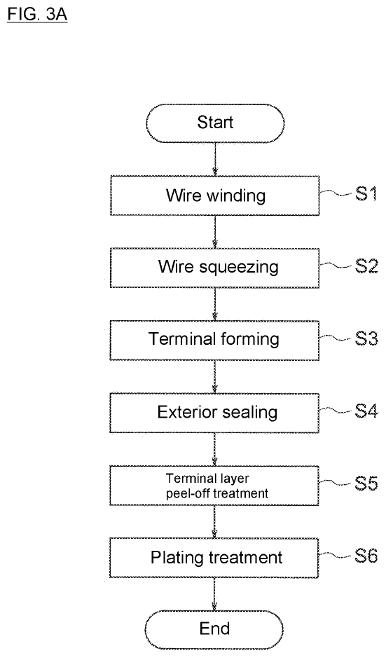

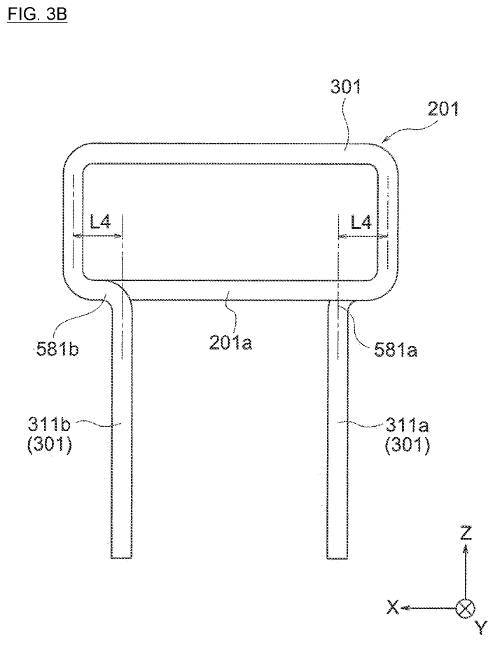

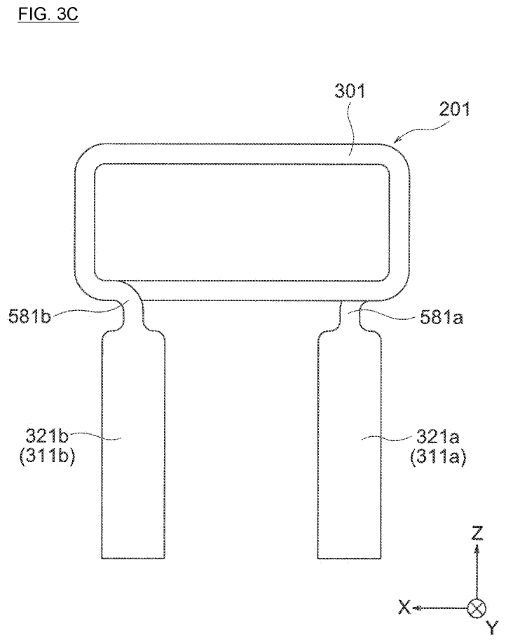

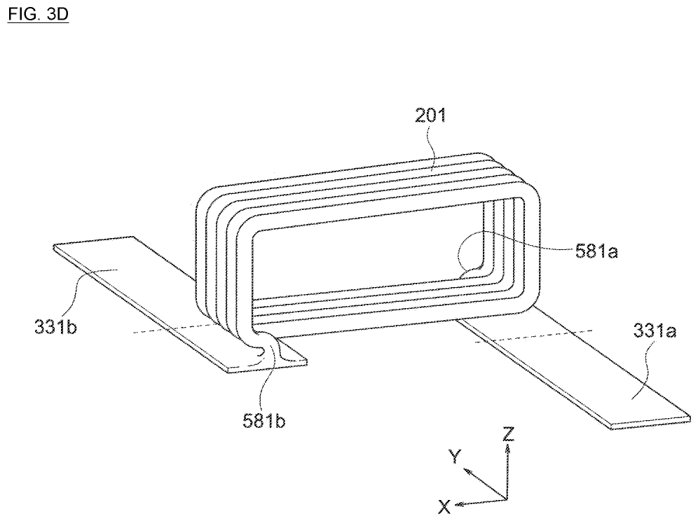

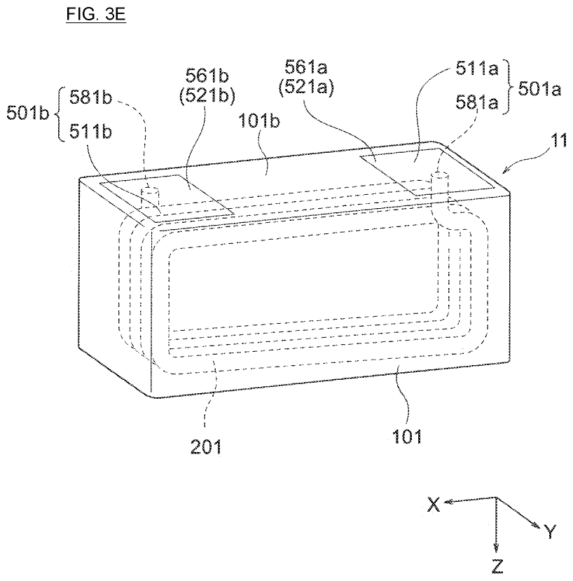

A method of manufacturing the coil component 11 will be explained next with reference to FIGS. 3A to 3E.

In manufacture of the coil component 11, first, the wire 301 is wound with a winding apparatus (not illustrated in the drawings) to form the air core coil 201 shown in FIG. 3B (step S1). Wire ends 311a and 311b of the wire 301, which has been wound, are extended inwards (towards the inner side in the X-axis direction) by the predetermined length L4 along a lower-side (in the Z-axis direction) portion 201a of the air core coil 201. Then, the wire ends 311a and 311b are bent towards the outside (downwards in the Z-axis direction) substantially at a right angle. A predetermined length of the wire ends 311a and 311b is secured, and the wire ends 311a and 311b are cut. At this stage, boundaries between the air core coil 201 and the wire ends 311a and 311b are formed as the lead-out portions 581a and 581b.

The wire ends 311a and 311b are then squeezed (flattened, pressed) as shown in FIG. 3C to form squeezed portions 321a and 321b having a sheet shape (step S2). Squeezing is performed by disposing the wire ends 311a and 311b of the wire 301 between top and bottom punches (of a convex tool) or pushing the wire ends 311a and 311b against a predetermined mold and pressing them. At this time, appropriate selection of a frame or a mold, appropriate determination of pressing intensity, appropriate post processing (e.g., cutting after squeezing), or the like can give the squeezed portions 321a and 321b having a desired stretch rate, stretch length, squeeze thickness, squeeze rate, or shape.

At the time of squeezing, for example, by disposing the wire 301 substantially at a center of the mold in its width direction and pressing it with uniform pressure applied in the width direction, the terminal bodies 511a and 511b having a ratio L6:L7 of substantially 50:50 can be formed as shown in FIG. 2G, where L6 and L7 are the width between the lead-out formation location 591a and both sides of the terminal body 511a (511b).

In contrast, at the time of squeezing, by pressing the wire 301 under the condition that a wall-shaped member is disposed on one side of the wire 301 or under the condition that the wire 301 is disposed at an off-centered location in the mold in its width direction, or by pressing the wire 301 in a certain diagonal direction, the terminal bodies 511a and 511b having a widthwise imbalanced form with respect to the lead-out formation location 591a to have a ratio L8:L9 of substantially 20:80 can be formed as shown in FIG. 2H, where L6 and L7 are widths of both sides of the terminal body 511a (511b) where the lead-out formation location 591a is the center.

After squeezing, the electrode terminals 501a and 501b are formed (“forming”) next (step S3). That is, as shown in FIG. 3D, the squeezed portions 321a and 321b are bent so that their respective end sides pass below the air core coil 201 to extend towards opposite sides, and excessive portions 331a and 331b are cut. Either bending of the squeezed portions 321a and 321b or cutting of the excessive portions 331a and 331b may be carried out prior to the other.

The air core coil 201 is then encased in the element body 101 (exterior sealing) (step S4). Exterior sealing of the air core coil 201 is performed by, for example, arranging a plurality of coil portions 201 in a mold frame, injecting a resin into the mold frame and hardening the resin, and then singulating the molded coil portions 201. Because the terminal bodies 511a and 511b have a sheet shape, the electrode terminals 501a and 501b, which have been formed in the previous step, can stand on their own when the terminal bodies 511a and 511b are positioned at the lower side, and the coil portions 201 can be easily arranged in the exterior sealing step. Cutting into individual coil components may be performed immediately after the exterior sealing step or may be performed after a terminal layer peel-off treatment step (explained later) or a plating treatment step (explained later).

After each coil portion 201 is encased by the resin (after exterior sealing), the terminal layer peel-off treatment is performed (step S5). On the electrode terminal outer surfaces 521a and 521b, there may be a remaining insulating layer covering the conductor portion of the wire 301, adhesion of the insulating layer of the wire 301 that has adhered at the time of squeezing, or adhesion of sealing resin that has adhered at the time of exterior sealing. Thus, the resin adhered to at least the outer surfaces 521a and 521b of the electrode terminals 501a and 501b is removed by, for example, polishing with a blade or laser irradiation to ensure that the electrode terminal outer surfaces 521a and 521b are exposed to the outside. In this step, the main surface (bottom surface) 101b may be smoothed by, for example, simultaneously polishing the main surface 101b of the element body 101 entirely. The terminal layer peel-off treatment may be performed before squeezing of the wire ends. In this case, through the exterior sealing step in which the air core coil 201 is encased in the element body 101, the element body can be formed to cover the electric element so that the outer surfaces of the electrode terminals are exposed. To ensure exposure of the outer surfaces of the electrode terminals, the resin covering the outer surfaces of the electrode terminals may be removed (peeled off) after the exterior sealing step by, for example, further polishing with the blade or laser irradiation.

The plating films 561a and 561b are then formed (step S6) as shown in FIG. 3E on the outer surfaces 521a and 521b appropriately exposed to the main surface 101b of the element body 101. When there is no need to form the plating films 561a and 561b on the outer surfaces 521a and 521b, it may be that the plating treatment is not performed.

The coil component 11 may be manufactured with such a method.

As explained above, because the electrode terminals 501a and 501b are formed by squeezing the ends of the wire 301 of the coil portion 201 of the coil component 11 of the present embodiment, no separate member for connecting the coil portion 201 and the electrode terminals 501a and 501b is needed. Consequently, the coil component 11 can be reduced in size. Also, need for joining or attaching a joining member is eliminated, which simplifies the manufacturing steps.

Also, because no separate member for connecting the coil portion 201 as an electric element and the electrode terminals 501a and 501b is present to integrally and continuously structure the electric element and the electrode terminals without boundaries (seamlessly), a resistive component of the electronic component is reduced. Consequently, inductors such as the coil component 11 of the present embodiment in particular can have a high Q factor. Such a coil component 11 is particularly effective as a coil component used at high frequencies.

Also, because the possibility of connection failures between the electric element and the electrode terminals is eliminated in the coil component 11 of the present embodiment, it is possible to provide a coil component having less failures and high reliability with long life.

Also, because the lead-out portions 581a and 581b of the coil component 11 of the present embodiment are drawn out from the lower side of the coil portion 201 to connect to the electrode terminals 501a and 501b, the lead-out portions 581a and 581b do not need to be disposed over to the outer side of the region where the coil portion 201 is formed. Also in this respect, the coil component 11 can be reduced in size.

Such a structure of the lead-out portions 581a and 581b allows the lead-out portions 581a and 581b to be shortened. Thus, impacts by the lead-out portions 581a and 581b on magnetic properties of the coil portion 201 can be reduced, and a resistive component of the lead-out portions 581a and 581b can be further reduced. Consequently, also in this respect, the Q factor can be increased.

### Second Embodiment

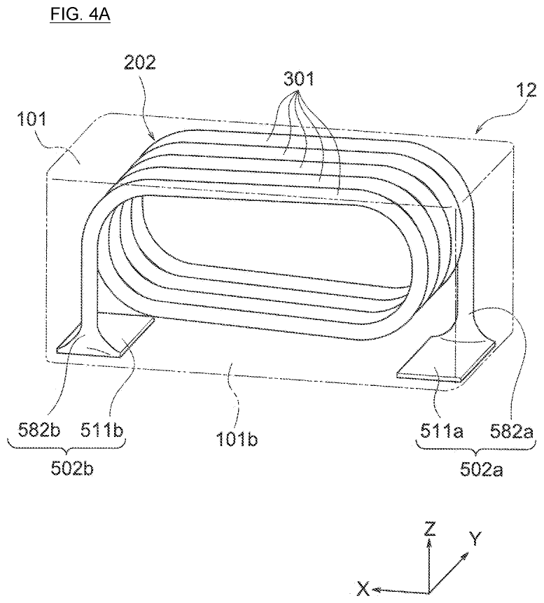

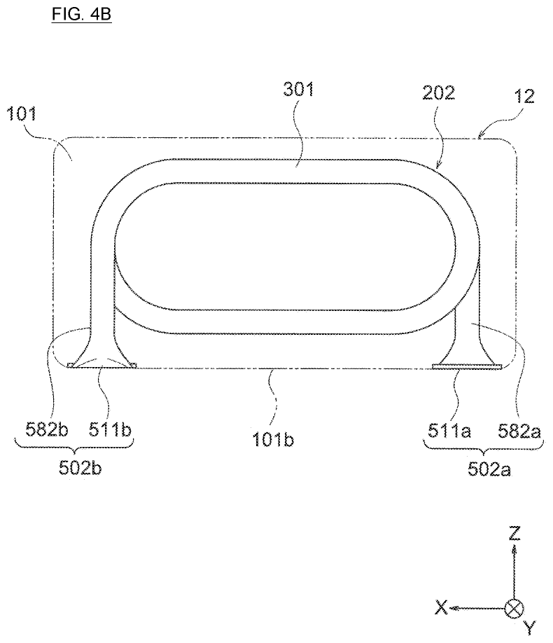

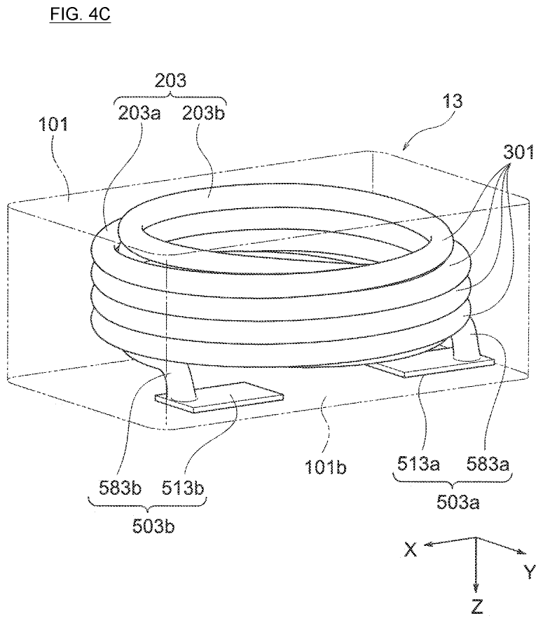

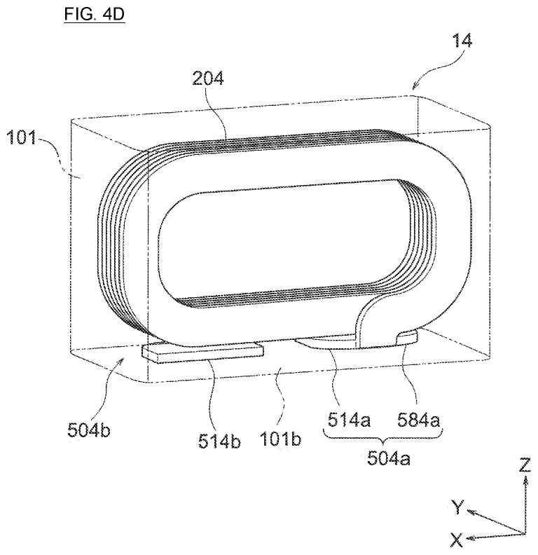

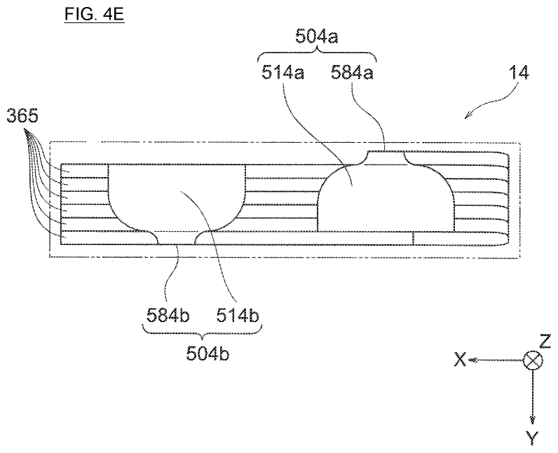

A coil component 12 of a second embodiment will be explained with reference to FIGS. 4A and 4B.

In description of the following second to fifth embodiments and other modified examples, structures common to the coil component 11 of the first embodiment are given the same reference numerals as in the first embodiment, and their detailed description is omitted. Difference from the first embodiment will be explained.

The coil component 12 of the second embodiment includes an air core coil 202 and a pair of electrode terminals 502a and 502b. The electrode terminals 502a and 502b include the respective terminal bodies 511a and 511b and respective lead-out portions 582a and 582b.

The lead-out portions 582a and 582b of the coil component 12 of the second embodiment have a structure different from that of the lead-out portions 581a and 581b of the coil component 11 of the first embodiment. As shown in FIGS. 4A and 4B, the lead-out portions 582a and 582b of the coil component 12 of the second embodiment extend from both ends (the winding start part and the winding end part) of the wire 301 of the air core coil 202 at outer sides in the X-axis direction straight to the main surface 101b side (lower side in the Z-axis direction) and connect (continue) to the terminal bodies 511a and 511b. That is, the lead-out portions 582a and 582b of the coil component 12 of the second embodiment do not have part extending inwards from the outer sides in the X-axis direction of the coil portion 202.

Consequently, the structure of the lead-out portions 582a and 582b of the coil component 12 of the second embodiment can be simple.

Although the terminal bodies 511a and 511b of the coil component 12 of the second embodiment are disposed so as to stick out from a region where the air core coil 202 is present in the plane (X-Y plane) parallel to the mounting surface, degree of the sticking out may be reduced or eliminated. For such purposes, a location (lead-out formation location) of the lead-out portion 582a (582b) with respect to the terminal body 511a (511b) may be off-centered to the outer side in the width direction of the terminal body 511a (511b), for example, as mentioned previously with reference to FIG. 2H.

Other structures are substantially the same as those of the coil component 11 of the first embodiment. For example, the electrode terminals 502a and 502b of the coil component 12 of the second embodiment are also formed by squeezing both ends of the wire 301 of the air core coil 202. Consequently, the coil component 12 of the second embodiment also exhibits the same effects as the coil component 11 of the first embodiment does.

### Third Embodiment

A coil component 13 of the third embodiment will be explained with reference to FIG. 4C.

The coil component 13 of the third embodiment has a structure in which a coil portion 203 is accommodated in the element body 101 so that the winding axis of the coil portion 203 is disposed perpendicular to the mounting surface (horizontal placement).

The coil component 13 of the third embodiment includes the coil portion 203 and a pair of electrode terminals 503a and 503b. The electrode terminals 503a and 503b include respective terminal bodies 513a and 513b and respective lead-out portions 583a and 583b.

The coil portion 203 includes an outer winding part 203a and an inner winding part 203b, which are composed of one wire 301 wound in two (inner and outer) layers. One end of the wire 301 is drawn out from a lower portion (main surface 101b side) of the outer winding part 203a towards the outside of the coil portion 203, and the other end of the wire 301 is drawn out from a lower portion (main surface 101b side) of the inner winding part 203b towards the outside of the coil portion 203. The outer winding part 203a and the inner winding part 203b are continued (connected) at an upper portion (in the Z-axis direction) of the coil portion 203.

One end of the wire 301 drawn out from the lower portion of the outer winding part 203a constitutes the lead-out portion 583a of the electrode terminal 503a, and the other end of the wire 301 drawn out from the lower portion of the inner winding part 203b constitutes the lead-out portion 583b of the other electrode terminal 503b. The lead-out portions 583a and 583b continue to the respective terminal bodies 513a and 513b disposed along the main surface 101b.

In the present embodiment, the electrode terminals 503a and 503b (the lead-out portions 583a and 583b and the terminal bodies 513a and 513b) are disposed along a front-side edge (positive direction of the Y-axis) of the main surface 101b of the element body 101 as shown in FIG. 4C. However, arrangement of the electrode terminals 503a and 503b in the plane (X-Y plane) parallel to the mounting surface (main surface 101b) may be placed at any location within a region occupied by the coil portion 203 in that X-Y plane.

Because the coil portion 203 of the coil component 13 of the third embodiment is disposed so that the winding axis of the coil portion 203 is perpendicular to the mounting surface (horizontal placement), such arrangement is particularly effective for height reduction of the electronic component. Moreover, because the region of the coil portion 203 with respect to the mounting surface, i.e., the region where the electrode terminals 503a and 503b are disposed, is widened, degree of freedom in disposing the electrode terminals 503a and 503b is improved.

Other structures are substantially the same as those of the coil component 11 of the first embodiment or the coil component 12 of the second embodiment. For example, the electrode terminals 503a and 503b of the coil component 13 of the third embodiment are also formed by squeezing both ends of the wire 301 of the air core coil 203. Consequently, the coil component 13 of the third embodiment also exhibits the same effects as the coil component 11 of the first embodiment or the coil component 12 of the second embodiment does.

### Fourth Embodiment

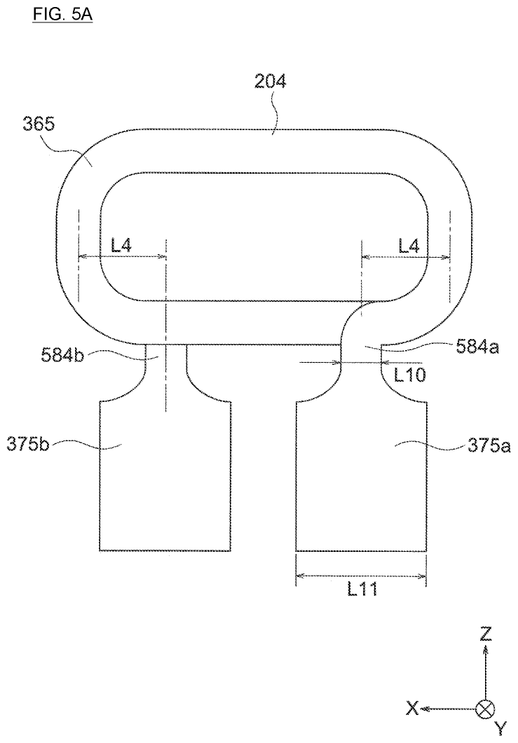

A coil component 14 of the fourth embodiment will be explained with reference to FIGS. 4D to 5A.

The coil component 14 of the fourth embodiment has a structure in which a coil portion 204 is made of an air core coil formed of a rectangular wire 365 that is edgewise wound.

The coil component 14 of the fourth embodiment includes the coil portion 204 and a pair of electrode terminals 504a and 504b. The electrode terminals 504a and 504b include respective terminal bodies 514a and 514b and respective lead-out portions 584a and 584b.

The coil portion 204 has a structure in which the rectangular wire 365 is edgewise wound and accommodated in the element body 101 so that the winding axis of the coil portion 204 is parallel to the mounting surface (vertical placement). Both ends of the rectangular wire 365 extend from outer sides of the coil portion 204 in the X-axis direction towards an inner side thereof, are bent at center-side locations of the coil component 14 towards the main surface 101b side, and are connected (continued) to the terminal bodies 514a and 514b.

The electrode terminals 504a and 504b of the coil component 14 of the fourth embodiment are also formed by squeezing both ends of the rectangular wire 365 of the air core coil 204.

In manufacture of the coil component 14, the rectangular wire 365 is edgewise wound to form the air core coil 204 shown in FIG. 5A. The wire ends of the rectangular wire 365, which has been wound, are extended inwards (towards the inner side in the X-axis direction) by the predetermined length L4 along a lower-side (in the Z-axis direction) portion of the air core coil 204. Then, the wire ends are bent downwards in the Z-axis direction at a substantially right angle. A predetermined length of the wire ends is secured, and the wire ends are cut. At this stage, boundaries between the air core coil 204 and the wire ends 311a and 311b are formed as the lead-out portions 584a and 584b.

Then, for example, by disposing the ends of the rectangular wire 365 between top and bottom punches and pressing them, squeezed portions 375a and 375b are formed as shown in, for example, FIG. 5A.

The squeezed portions 375a and 375b may be squeezed so that they have a width L11 that is, for example, at least twice as large as a pre-squeezing width L10 of the rectangular wire 365 in a cross section orthogonal to the extending direction of the rectangular wire 365. Squeezing may be performed so that L11 is 2.5 to 6 times the pre-squeezing width L10 of the rectangular wire 365 in the cross section. Although illustration in the drawing is omitted, the thickness of the rectangular wire (squeezed portions 375a and 375b) after squeezing may be smaller than a pre-squeezing thickness of the rectangular wire 365. For example, the thickness of the squeezed portions 375a and 375b may be 50% or less (½ or less) of the pre-squeezing thickness. The squeezed portions 375a and 375b may have a minimum thickness that is 5% or more ( 1/20 or more), 10% or more ( 1/10 or more), or 25% or more (¼ or more) of the pre-squeezing thickness of the rectangular wire 365. A ratio (thickness: width) between the thickness and the width of the squeezed portions may be 1:5 to 1:15.

Other structures of such a coil component 14 including the rectangular wire 365 are substantially the same as those of the coil components 11 to 13 of the first to third embodiments. Consequently, the coil component 14 of the fourth embodiment also exhibits the same effects as the coil components 11 to 13 of the first to third embodiments do.

### Fifth Embodiment

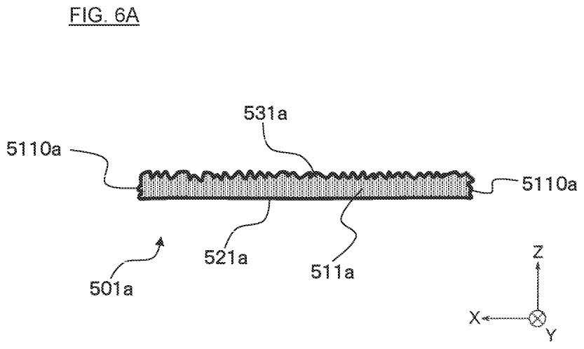

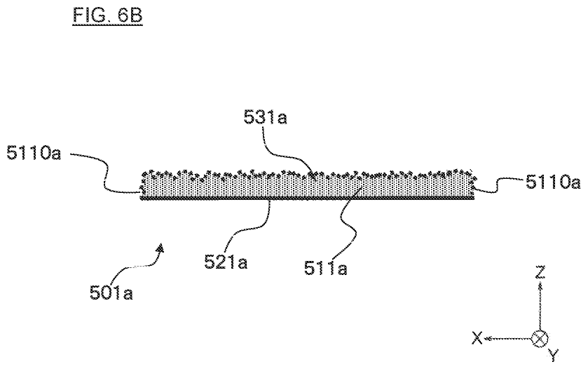

A coil component of the fifth embodiment will be explained with reference to FIGS. 6A and 6B.

The coil component of the fifth embodiment is a coil component in which surface roughness is different between the outer surfaces (first main surfaces) 521a and 521b and other surfaces (surfaces other than the outer surfaces) including the inner surfaces (second main surfaces) 531a and 531b of the terminal bodies 511a and 511b of the electrode terminals 501a and 501b of, for example, the coil component 11 shown in FIG. 1A. Although this structure (characteristic) is applicable to all coil components 11 to 14 of the first to fourth embodiments in the same way, a coil component 15 in which this structure is applied to the coil component 11 of the first embodiment will be explained with reference to FIG. 1A.

FIGS. 6A and 6B are schematic views of one electrode terminal 501a of the coil component 15 shown in FIG. 1A. FIG. 6A schematically illustrates a condition in which surfaces other than the outer surface 521a of the terminal body 511a of the electrode terminal 501a are roughened by a mechanical method (physical method). FIG. 6B schematically illustrates a condition in which the surfaces other than the outer surface 521a of FIG. 6A are further roughened by a chemical method (e.g., etching).

As shown in FIGS. 6A and 6B, the outer surfaces 521a and 521b of the terminal bodies 511a and 511b of the electrode terminals 501a and 501b are formed to be flat surfaces, and the inner surfaces 531a and 531b thereof are formed to be surfaces having predetermined surface roughness. That is, the inner surfaces 531a and 531b are formed to be surfaces rougher than (having larger surface roughness than) the outer surfaces 521a and 521b.

Side surfaces 5110a (four side surfaces (of all directions) of the terminal body 511a having a substantially rectangular shape; the reference numeral 5110a is given only to the side surfaces facing each other in the X-axis direction in FIGS. 6A and 6B) of the terminal body 511a are also formed to be surfaces having the same predetermined surface roughness as the inner surface 531a.

That is, in the coil component 15 of the present embodiment, the surfaces other than the outer surface (i.e., the inner surface 531a and the side surfaces 5110a of the terminal body 511a) are formed to be the surfaces rougher than the outer surface 521a. In other words, in the coil component 15 of the present embodiment, among surrounding surfaces of the electrode terminal 501a, the surfaces that are embedded into the element body 101 and are in contact with the resin (exterior resin) forming the element body are rougher than the outer surface 521a exposed outside the coil component 15. Specifically, the outer surface 521a of the terminal body 511a of the electrode terminal 501a may have an arithmetic average roughness Rz (JIS B 0601:2013) of, for example, 1 μm to 5 μm. The surfaces other than the outer surface 521a of the terminal body 511a of the electrode terminal 501a may have an arithmetic average roughness Rz (JIS B 0601:2013) of 1 μm to 5 μm. Alternatively, the surfaces other than the outer surface 521a of the terminal body 511a of the electrode terminal 501a may have an arithmetic average roughness Rz (JIS B 0601:2013) that is 100% or more and 500% or less, 200% or more and 500% or less, or 300% or more and 500% or less of that of the outer surface 521a.

By forming the outer surfaces 521a and 521b into the flat surfaces, quality of the plating films 561a and 561b (FIG. 1B) formed on the outer surfaces 521a and 521b can be improved. That is, the plating films 561a and 561b having high flatness can be formed without occurrence of plating peel-off or the like. Consequently, bondability between the outer surfaces 521a and 521b and a joining member for joining the coil component 15 to an external circuit is improved, which can improve reliability of the coil component 15 when it is mounted. Even when the plating films 561a and 561b are not formed on the electrode terminal outer surfaces 521a and 521b, the bondability between the electrode terminal outer surfaces 521a and 521b and the joining member or the external circuit can be improved.

By forming the surfaces of the terminal bodies 511a and 511b other than the outer surfaces (i.e., the surfaces that are in contact with the element body 101) into the rough surfaces, adhesion of these surfaces to the element body 101 can be improved. Consequently, the electrode terminals 501a and 501b and the element body 101 can be firmly bonded. In particular, because the element body 101 is formed of the resin material, forming the surfaces of the terminal bodies 511a and 511b in contact with the element body 101 into the rough surfaces improves the adhesion to exhibit so-called anchoring effects, which allow for firm bonding between the electrode terminals 501a and 501b and the element body 101.

As mentioned earlier, the thickness T2 (FIG. 2D) of the terminal body 511a is freely determined. When the thickness of the terminal body 511a is relatively large, i.e., μm or more, the side surfaces 5110a (FIGS. 6A and 6B) of the terminal body 511a have a large area, which exhibit improved fastenability to the element body 101 once the side surfaces 5110a are roughened. In such a form, roughening the side surfaces 5110a of the terminal body 511a is effective.

Methods of forming such rough surfaces on the electrode terminals 501a and 501b may include mechanical (physical) methods (e.g., squeezing, knurling, and grinding), chemical methods (e.g., etching, chemical polishing, and electropolishing), and a combination of both in sequence (in two steps or step by step).

As a mechanical (physical) method, for example, punches having different surface roughness may be used on top and bottom to squeeze the wire 301 in the step S2 (squeezing) described previously with reference to FIG. 3A. That is, a punch whose contact surface with the wire 301 has high surface roughness is used as a punch that abuts sides that become the outer surfaces 521a and 521b; and a punch (a fine punch) whose contact surface with the wire 301 has low surface roughness is used as a punch that abuts sides that become the inner surfaces 531a and 531b. Alternatively, surface roughness of the front and the back of the squeezed portions 321a and 321b (FIG. 3C) may be changed by separately machine processing the front and the back after squeezing. At this time, the terminal layer peel-off treatment described previously may be performed before squeezing of the wire ends. In this case, desired squeezing can be performed efficiently in a short amount of time.

Through such mechanical roughening, the surfaces other than the outer surface 521a are roughened as shown in FIG. 6A. This can increase the surface area of the contact surface with the element body 101 and can improve adhesion between these surfaces and the element body 101. In particular, because the element body 101 is formed of the resin material, forming the surfaces other than the outer surface 521a of the terminal body 511a into the rough surfaces exhibits the anchoring effects. Also in this respect, adhesion improves to allow for firm bonding between the terminal bodies 511a and 511b and the element body 101. Consequently, the electrode terminal 501a can be firmly bonded to the element body 101.

As a chemical method, for example, etching may be performed. For example, further performing etching on the surfaces physically roughened as shown in FIG. 6A can roughen these surfaces so as to make them finely uneven (so-called three-dimensional roughening) as schematically shown in FIG. 6B. This can further increase the surface area of the contact surface with the element body 101, further exhibit the anchoring effects, and further improve the adhesion between the electrode terminal 501a and the element body 101.

During etching, the electrode terminal may be etched entirely, or freely selected spots of the electrode terminal may be etched (roughened) while spots not subject to roughening are appropriately masked. For example, the surfaces other than the outer surface 521a of the terminal body 511a may be etched easily by masking only the outer surface 521a of the terminal body 511a and performing etching.

Roughening of the surfaces of the electrode terminals 501a and 501b may be performed by only physical roughening or by only chemical roughening. Both may be performed in sequence (in two steps). Moreover, all surfaces (including the outer surfaces 521a and 521b) of the electrode terminals 501a and 501b may be roughened into predetermined roughness, and then the outer surfaces 521a and 521b may be polished or subjected to other treatments to be formed into fine flat surfaces, to make the surfaces other than the outer surfaces relatively rough.

Roughening is not required to be performed on all surfaces (all surfaces other than the outer surface 521a) of the electrode terminals 501a and 501b. For example, only the inner surfaces 531a and 531b, which are in contact with the element body 101 at a large contact area, may be roughened, or only the surrounding surfaces (side surfaces) 5110a, where the terminal bodies 511a and 511b readily peel off from the element body 101, may be roughened. Degree of roughening may differ among surfaces subject to roughening.

### Other Modified Examples

The present disclosure is not limited to the above-mentioned embodiments and may variously be modified in any favorable manner.

For example, in each of the above-mentioned embodiments, the thickness of the terminal bodies of the electrode terminals is not required to be uniform, and the terminal bodies may have a thick portion or a thin portion. For example, the plate thickness of ends (away from the lead-out portions 581a and 581b) of the terminal bodies 511a and 511b, which are formed by squeezing the wire, of the electrode terminals 501a and 501b shown in FIG. 1A may be larger than that of other regions of the terminal bodies 511a and 511b (central regions of the terminal bodies 511a and 511b or regions thereof closer to the lead-out portions 581a and 581b).

With regard to thickening the plate thickness of such ends of the terminal bodies 511a and 511b, the thickness is at least a little larger than that of the central regions of the terminal bodies 511a and 511b. For example, the thickness may be 1.01 times or more, 1.5 times or more, 2 times or more, 5 times or more, 10 times or more, or times or more of the thickness of the central regions.

Although the element body 101 of the above-mentioned embodiments contains the resin material that does not include a magnetic material, the element body may be composed of a magnetic powder-containing resin that includes a magnetic powder.

The magnetic powder may be any magnetic powder and may include metal magnetic particles. Examples thereof include pure Fe, an Fe—Ni based alloy, an Fe—Si based alloy, an Fe—Co based alloy, an Fe—Si—Cr based alloy, an Fe—Si—Al based alloy, amorphous metal, a nano-crystalline alloy containing Fe, other soft magnetic alloys, and combinations thereof.

The magnetic particles may include ferrite particles. Examples of ferrite materials include a Ni—Zn based ferrite and a Mn—Zn based ferrite.

A subcomponent may be added to the magnetic powder as appropriate.

The metal magnetic particles included in the element body 101 may be insulated from each other. Examples of insulating methods include a method of forming an insulating film on a particle surface. Examples of the insulating film include a film formed from a resin or an inorganic material, and an oxidized film formed by oxidizing the particle surface in a heat treatment. When the insulating film is formed from a resin or an inorganic material, examples of the resin include a silicone resin and an epoxy resin.

Examples of the inorganic material include phosphates (e.g., magnesium phosphate, calcium phosphate, zinc phosphate, and manganese phosphate), silicates (e.g., sodium silicate (water glass)), soda lime glass, borosilicate glass, lead glass, aluminosilicate glass, borate glass, and sulfate glass. The thickness of the insulating film of the magnetic particles may be 5 nm to 200 nm. Formation of the insulating film can improve insulation properties among the particles and can improve, for example, the withstand voltage of the coil component.

The electronic component is not limited to a coil component (e.g., inductor) including the element body in which the coil portion is embedded. The electronic component may be, for example, a coil component in which a wire is wound around a dust core, a reactor, a transformer, or a contactless power supply device.

### REFERENCE NUMERALS

11 to 15 . . . coil component (electronic component)
101 . . . element body
101a . . . upper surface
101b . . . main surface (bottom surface)
101c to 101f . . . side surface
201 to 204 . . . air core coil (coil portion, electric element)
301 . . . wire (round wire)
311a, 311b . . . wire end
321a, 321b . . . squeezed portion
331a, 331b . . . excessive portion
365 . . . rectangular wire (wire)
375a, 375b . . . squeezed portion
501a to 510a, 501b to 504b . . . electrode terminal
511a to 514a, 511b to 514b . . . terminal body
521a, 521b . . . outer surface (first main surface)
531a, 531b . . . inner surface (second main surface)
561a, 561b . . . plating film
581a to 587a, 581b to 584b . . . lead-out portion
591a . . . lead-out formation location

What is claimed is:

1. An electronic component comprising:
an element body;
an electric element embedded inside the element body; and
an electrode terminal connected to the electric element so as to be exposed to an outer surface of the element body;
wherein
the electrode terminal comprises a terminal body continuously and integrally formed with a wire of the electric element embedded inside the element body and extending in a planar shape along a main surface of the element body; and
the wire is drawn out to an outside of the element body from the main surface of the element body to form the electrode terminal.

2. The electronic component according to claim 1, wherein
the terminal body has a thickness smaller than that of the wire; and
the terminal body has a width larger than that of the wire.

3. The electronic component according to claim 2, wherein the terminal body extends in the planar shape along the main surface in a direction towards a center of the electric element.

4. The electronic component according to claim 1, wherein the electric element comprises a coil portion made of the wire.

5. The electronic component according to claim 2, wherein the electric element comprises a coil portion made of the wire.

6. The electronic component according to claim 3, wherein the electric element comprises a coil portion made of the wire.

7. The electronic component according to claim 1, wherein the element body comprises a resin.

8. The electronic component according to claim 2, wherein the element body comprises a resin.

9. The electronic component according to claim 3, wherein the element body comprises a resin.

10. The electronic component according to claim 7, wherein the element body further comprises a magnetic powder.

11. The electronic component according to claim 8, wherein the element body further comprises a magnetic powder.

12. The electronic component according to claim 9, wherein the element body further comprises a magnetic powder.

13. The electronic component according to claim 1, wherein at least an inner surface or a side surface of the terminal body in contact with the element body has surface roughness larger than that of an outer surface of the terminal body opposite the inner surface.

14. The electronic component according to claim 2, wherein at least an inner surface or a side surface of the terminal body in contact with the element body has surface roughness larger than that of an outer surface of the terminal body opposite the inner surface.

15. The electronic component according to claim 3, wherein at least an inner surface or a side surface of the terminal body in contact with the element body has surface roughness larger than that of an outer surface of the terminal body opposite the inner surface.

16. The electronic component according to claim 1, wherein a plating film is formed at an outer surface of the terminal body opposite an inner surface thereof in contact with the element body.

17. The electronic component according to claim 2, wherein a plating film is formed at an outer surface of the terminal body opposite an inner surface thereof in contact with the element body.

18. The electronic component according to claim 3, wherein a plating film is formed at an outer surface of the terminal body opposite an inner surface thereof in contact with the element body.

19. A method of manufacturing an electronic component, comprising:
forming an electrode terminal by processing an end of a wire of an electric element into a sheet shape so that the end has a thickness smaller than that of the wire apart from the end and a width larger than that of the wire apart from the end; and
forming an element body so that an outer surface of the electrode terminal is exposed from the element body and the electric element is covered by the element body.
